(19) United States
(12) Patent Application Publication
(10) Pub. No.: US 2018/0108078 A1
(43) Pub. Date: Apr. 19, 2018

(54) SYSTEMS AND METHODS FOR CONTROLLING A DISPLAY OF CONTENT IN A RETAIL STORE

(71) Applicant: Wal-Mart Stores, Inc., Bentonville, AR (US)

(72) Inventor: Daniel Howell, Bentonville, AR (US)

(21) Appl. No.: 15/729,843

(22) Filed: Oct. 11, 2017

Related U.S. Application Data
(60) Provisional application No. 62/408,158, filed on Oct. 14, 2016.

(51) Int. Cl. G06Q 30/06; G06Q 30/02; G06Q 10/08; G01C 21/20; H04W 4/04

(52) U.S. Cl. CPC G06Q 30/0643; G06Q 30/0259; H04W 4/04; G06Q 10/087; G01C 21/206; G06Q 30/0639

(57) ABSTRACT

A system that controls a presentation of digital content comprises at least one electronic display positioned in a retail shopping environment; a mobile device that filters, changes, or replaces content for display at the electronic display; at least one controller that controls an output of the content to the at least one electronic display in response to a request for a change in content received from the mobile device; and a user-configurable sphere of influence that establishes a distance of the mobile device from the at least one controller and determines whether at least one electronic display receives the controlled output of content based on proximity of the mobile device from the at least one controller.

### RELATED APPLICATIONS

This application claims the benefit of U.S. Provisional Patent No. 62/408,158, filed Oct. 14, 2016, entitled “Systems and Methods for Controlling a Display of Content in a Retail Store,” the contents of which are incorporated by reference herein in their entirety.

### TECHNICAL FIELD

The present inventive concepts relate to electronic shelf labels and digital signs, and more specifically, to the controlled display of content in a retail store environment using electronic shelf labels and digital signs.

### BACKGROUND

A central computer server is typically used to control the display of content displayed at an electronic shelf label or digital sign. However, this is ineffective for customers who may want to access different information than what is currently displayed on the electronic shelf label (ESL) or digital sign.

### SUMMARY

In one aspect, provided is a system that controls a presentation of digital content, comprising: at least one electronic display positioned in a retail shopping environment; a mobile device that filters, changes, or replaces content for display at the electronic display; at least one controller that controls an output of the content to at least one electronic display in response to a request for a change in content received from the mobile device; and a user-configurable sphere of influence that establishes a distance of the mobile device from the at least one controller and determines whether the at least one electronic display receives the controlled output of content based on proximity of the mobile device from the at least one controller.

In some embodiments, the system further comprises a content server that stores alternative content that replaces the content for display on the electronic display in response to the request for the change in content.

In some embodiments, the alternative content guides users between store locations, by providing directional indicators in response to the mobile device generating a request for a route through the retail shopping environment.

In some embodiments, the content server stores a plurality of records that include content item data and associated index codes.

In some embodiments, the electronic display includes at least one of a visual display, digital sign, or a kiosk display, an end cap display, or an electronic shelf label.

In some embodiments, the system further comprises an audio device that outputs audio content, wherein the mobile device that filters, changes, or replaces content for output from the audio device.

In some embodiments, the mobile device includes a content-specific filter field that controls the type of content of interest to the user, and wherein the electronic display displays the alternative content in response to the content-specific filter field.

In some embodiments, the alternative content is displayed within a predetermined distance from the mobile device to allow multiple shoppers in a general area while filtering by different preferences.

In some embodiments, the controller is in proximity to a first shopper and a second shopper of the multiple shoppers, wherein the controller uses metadata from each shopper's mobile device to determine which displays of the at least one electronic display is capable of being changed to an alternative display state for each shopper.

In some embodiments, each of the first and second shoppers is in a different sphere of influence, and wherein the metadata is used to distinguish the first and second shoppers.

In some embodiments, the system further comprises a physical location processor that manages the location of known display locations and recognizes data coming from a mobile device to determine a match in locations.

In some embodiments, the mobile device transmits to allow the at least one electronic display to pull content associated to the index.

In some embodiments, the mobile device passively controls what content is filtered on the at least one electronic display as the user walks through a store in the presence of the at least one electronic display.

In some embodiments, the size of the sphere of influence is adjustable.

In another aspect, provided is a controller that controls a presentation of digital content, comprising: a special purpose processor that modifies content displayed on an electronic display in a retail shopping environment in response to a request for a change in content received from a remote mobile device; and a special purpose processor that forms a user-configurable sphere of influence that establishes a distance from the mobile device, the special purpose processor further establishing whether the electronic display receives alternative content in response to the request for the change in content based on a proximity of the mobile device.

In another aspect, provided is a system that controls a presentation of digital content, comprising: at least one electronic display positioned in a retail shopping environment; a mobile device that outputs a request for a navigational route through the retail shopping environment; at least one controller that receives the request from the mobile device, the request including a request for navigation content; and a content server that stores the navigation content, the at least one electronic display displaying directions for the navigational route according to the navigation content.

In some embodiments, the navigational route is for stocking, shopping, or picking items of interest, or for a guided tour, audit, or re-stocking.

In some embodiments, the at least one controller receives a request for alternative content when the mobile device travels to a different location, the alternative content including direction data to the different location.

In some embodiments, different electronic displays display the directions for guiding the mobile device along the navigational route.

In another aspect, provided is a method for controlling a presentation of digital content, comprising determining if a shopper's mobile device opts-in or accesses a network for controlling a display of data at an electronic display; selecting at the mobile device a filter option; ratifying a relevant context, including determining whether the context is relevant; determining a proximity between the mobile device and a controller; providing the filter option from the mobile device to the controller; providing by the controller alternative content based on the proximity of the mobile device from the controller and the filter option; and displaying custom content on the electronic display near the shopper in response to a determination that the customer opts-in, the filter option is selected, the proximity is detected, and the context is relevant.

### BRIEF DESCRIPTION OF THE DRAWINGS

FIG. 1 is a block diagram of a retail store environment in which some embodiments of the inventive concepts are practiced.

FIG. 2 is a block diagram of a retail store environment in which other embodiments of the inventive concepts are practiced.

FIG. 3 is an illustrative view of example screenshots of default state and alternative state content, in accordance with some embodiments.

FIG. 4 is a diagram of a component model for an adaptive shelf display, in accordance with some embodiments.

FIG. 5 is a flow diagram of a method for controlling a presentation of digital content at a store display, in accordance with some embodiments.

FIG. 6 shows a catalog of filters with corresponding display codes, in accordance with some embodiments.

FIG. 7 is a block diagram of a schema illustrating example contexts that supplement content selection and formatting for an adaptive display, in accordance with some embodiments.

### DETAILED DESCRIPTION OF EMBODIMENTS

In brief overview, embodiments of the present inventive concepts permit store customers or employees to use personal computing devices, such as smartphones, electronic notebooks, and the like to passively or explicitly influence or control the content displayed at electronic shelf labels or other electronic displays and signs as the store customer walks through the store.

For example, a first customer may have certain food allergies, a second customer may prefer to filter out adult-rated media products, and a third customer may desire to avoid or opt-out of solicited advertising in the stores. A system is implemented so that the first customer is shown foods at an electronic sign that contain the relevant allergens, the second customer may only view “G-rated” or child-appropriate information on its electronic displays, and the third cannot view solicited advertisements on the store's adaptive displays, each display unique to the customer.

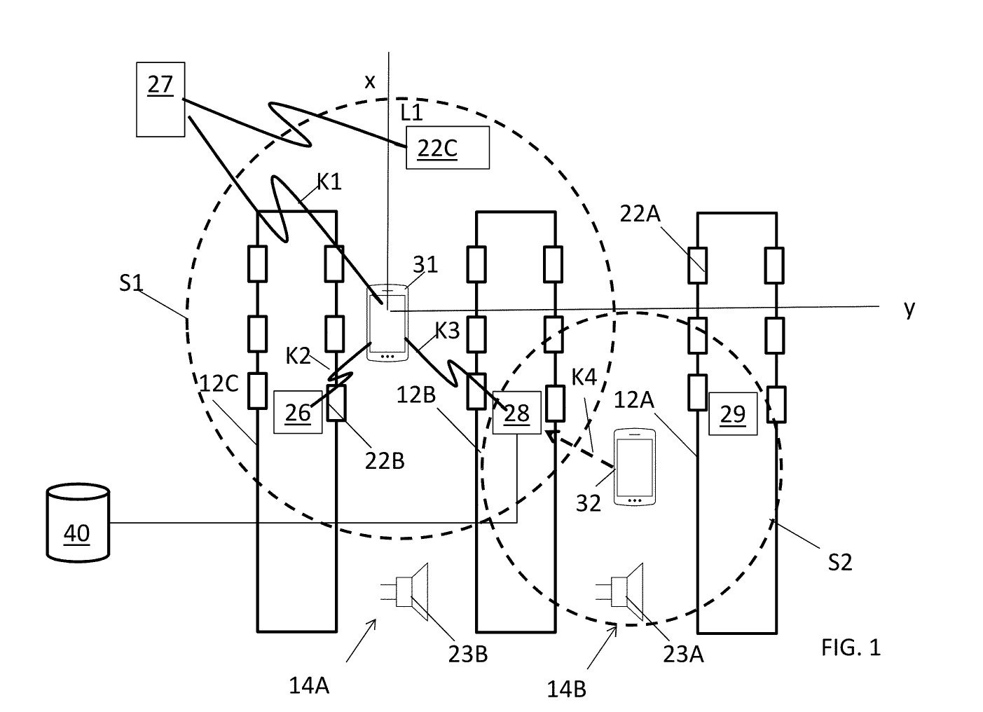

FIG. 1 is a block diagram of a retail store environment in which some embodiments of the inventive concepts are practiced. FIG. 1 illustrates an embodiment where smart devices, for example, mobile electronic devices 31, 32 such as smartphones, electronic notebooks, laptop computers, or the like can provide certain contexts, cues, and/or other control features to one or more store display control systems 26-29, even while other customers or employees are operating within the same relative geographic location of the store.

The retail store environment includes a plurality of shelves 12A-C (generally, 12) or other storage areas at which store items for purchase may be located. The shelves 12 may be arranged in an array, or other pattern, and may be separated from each other by aisles 14A, 14B (generally, 14).

A plurality of electronic displays 22A-D (generally, 22) may be located throughout the store. For example, as shown in FIG. 1, a first electronic display 22A may be at a first retail shelf 12A, a second display 22B may be located at a third retail shelf 12C, a third display 22C may be located at a second retail shelf 12B between shelves 12A and 12C, and a fourth display 22D may be located at an end of an aisle 14B between shelves 12B and 12C. An electronic display 22 may be an electronic shelf label, end-cap display, kiosk, television monitor, or other display that provides information to customers and/or store associates in a visual format. One or both displays 22 may display default and/or alternative audio content. Other content delivery devices may be positioned throughout the store such as a first audio speaker 23A positioned at aisle 14A, and a second audio speaker 23B positioned at aisle 14B. Speakers 23 may provide an accessibility aid for a vision-impaired user to supplement other displayed content. One or both speakers 23A, 23B may output default and/or alternative audio content. For example, audio speaker 23B may, in an alternative state, provide audio content to a user in aisle 14B.

Store display control systems 26-29 are configured to modify content displayed on one or more electronic displays 22 in response to a request for a change in content received from a mobile electronic device 31, 32. Store display control systems 26-29 may include media and content controllers that monitor a proximal region for data output from the mobile electronic devices 31, 32, the data including a request a change in content. The control systems 26-29 may communicate with the mobile electronic devices 31, 32 via a wireless communication medium, such as but not limited to WiFi, Low Energy Bluetooth, Near Field Communication (NFC), Infrared, audible or sub-audible transmission, radio, radio frequency identification (RFID), or the like.

For example, during operation, a first controller 26 is inside a sphere of influence S1 and closest in proximity to a customer or store associate mobile electronic device 31, and can communicate with the mobile electronic device 31 via an abovementioned wireless communication medium.

The sphere of influence S1 is calculated by settings from the mobile electronic device 31 in combination with settings and controls from the server system, for example, location and filter logic. A user of the mobile electronic device 31 may select items, categories, and/or departments that may be used as a guide or scale that determines the sphere configuration. The server system may ensure that the user, e.g., shopper or associate, is authorized to control the screens, display the right associate-facing content, and so on.

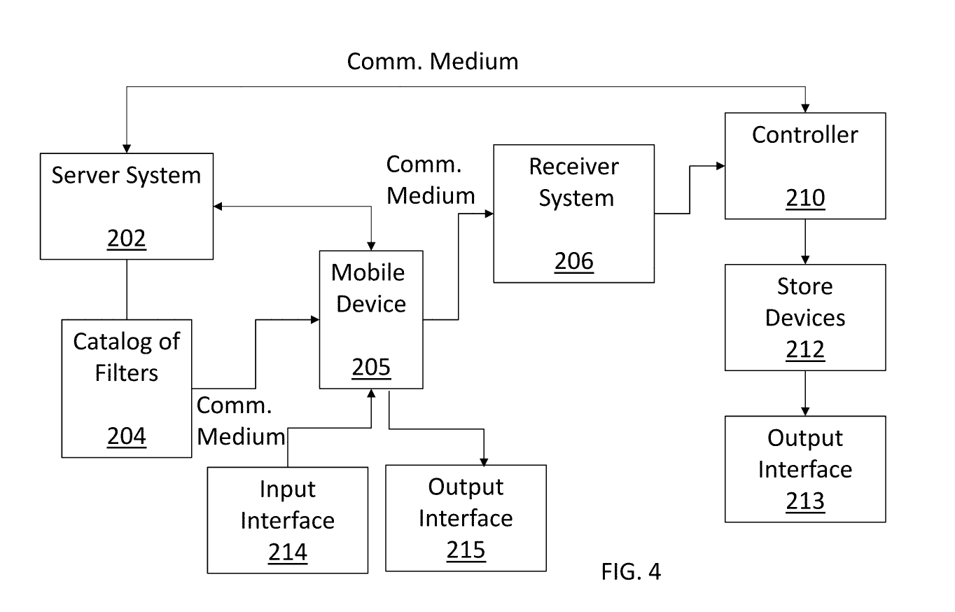

For example, an authorized user may adjust filter settings locally on the mobile electronic device 31. These settings, along with other contexts from the mobile devices sensors or metadata, may be output via a receiver system 206 (see FIG. 4) to be interpreted by the filters and location systems. The result is an activation of screens that fit the logic, or a “virtual” sphere of influence.

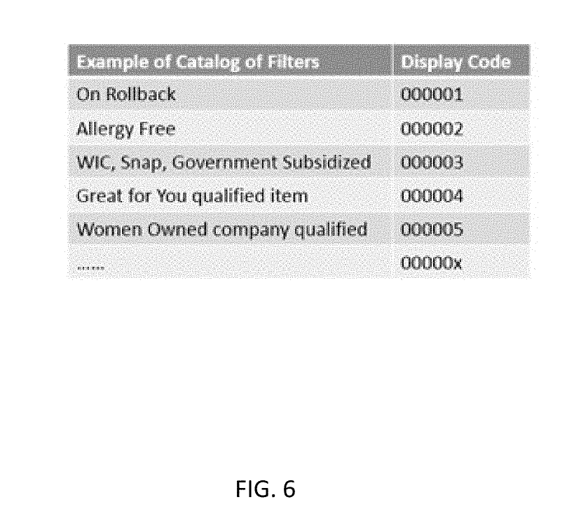

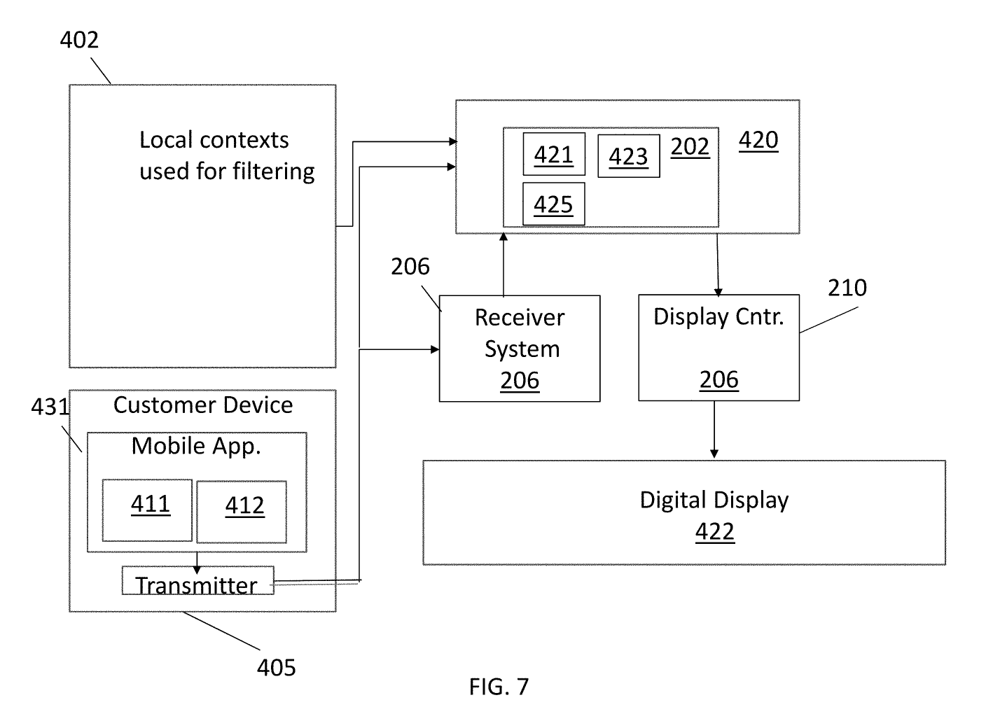

A second controller 27 is outside the sphere of influence S1 of the customer or store associate mobile electronic device 31, but can nevertheless control a display 22 proximate to the customer or store associate mobile electronic device 31, for example, alternate display 22C which is inside the sphere of influence S1. The second controller 27 can operate via a different communication medium than the first controller 26, but provide the same or similar functionality to the mobile device users in response to a content request. A content request may be initiated and output by the mobile device 31 included as part of a signal including a request for a type of content that the user prefers to be shown on the adaptive display 22. A content request may include a filter, for example, illustrated in FIG. 6, and accompanying contexts from the device, for example, including local device metadata 411 and customer filter options 412 illustrated in FIG. 7. Accordingly, the mobile device 31 may be the same or similar to a mobile device 405 described in FIG. 7.

A third controller 28 is also inside the sphere of influence S1 of the customer or store associate mobile electronic device 31. The third controller 28 may receive and process metadata from first user's mobile device 31 as well as a second user's mobile device 32 to determine which displays 22 are most likely to require changing to an alternative display state from each user. For example, FIG. 7, in particular, inputs 402, illustrate how a single display 422 may present information to multiple users simultaneously. In this example, the first user mobile device 31 may share information about relative signal strength between controllers and/or other store sensors so that the system can identify which controller and/or sensor are proximate to the first user mobile device 31.

The second user mobile device 32 may provide device level information, for example, a direction or orientation using a digital compass, which may be used to determine which displays and/or controllers the device 32 may be in proximity with and/or in communication with. Location-related information may be provided by GPS, WiFi triangulation, or other geo-location detection capability. In some embodiments, the compass direction of the device 32 may be used in conjunction with other metadata to determine which displays and controllers the device 32 is connected to. Additional sensors or capabilities on the mobile device 32 may be used to help determine the location and sphere of influence of the device 32. Sensors and data repositories may include but not be limited to GPS, radio antenna, accelerometers, pedometers, digital compasses, magnetometers, user-input, system and application memory, Bluetooth® Low-Energy (BLE), NFC, WiFi, RFID, and so on. Metadata related to one or more of the foregoing may be used to determine which displays and controllers a device 31, 32 is connected to. This data may augment and enhance the filters and content preferences selected by the mobile device user.

The user mobile devices 31, 32 may alternatively track historical behavior information such as item locations from a stored shopping list or basket, past behaviors such as purchase history, and prior interactions with content controllers, or filters that flag locations that are to be excluded from the user. For example, a user may select items from the shopping list displayed electronically on a smartphone, and proceed to the location of those items in the store. As the user arrives at the next item from the list, shelf displays may function as waypoints or direction markers to facilitate or assist the user in locating next items on the list, for example, displaying an “X” character, or an arrow symbol or other identifier.

In another example, a customer may remain a certain amount of time at a store location such as a service area near the pharmacy or money center. This “dwell pattern” may establish that the customer has not moved from a current location, and a signal may be output to a receiver system to run different content at display devices 22 near the customer, such as presenting additional information about how to get through lines quicker or performing steps online at home beforehand.

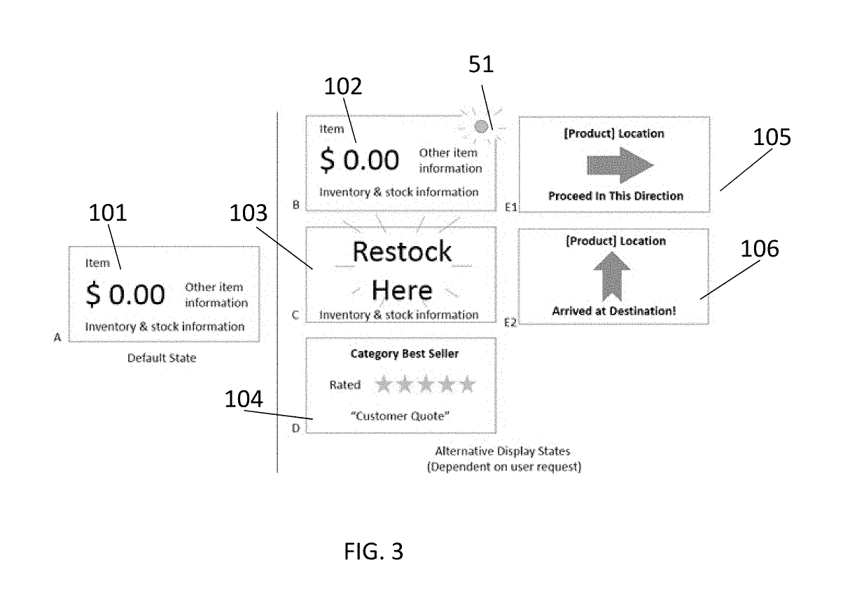

The retail store environment may include at least one content server 40 that stores or retrieves from other data repositories alternative content for display until a mobile device 31, 32 interacts with a controller 26-29 that then pulls alternative content from the content server 40. Alternative content stored at the content server 40 may replace content currently displayed on the electronic display 22 in response to a request for a change in content received from a mobile device 31, 32. FIG. 3 illustrates examples of alternative content. In some embodiments, the content server 40 stores a plurality of records that include content item data and associated index codes.

As previously described, the first sphere of influence S1 may surround the first user, more specifically, first user's mobile device 31. Similar, a second sphere of influence S2 may surround the second user, more specifically, second user's mobile device 32. The first user may elect to change the size of the first sphere of influence S1 from a wide area where many displays 22 may be activated by the mobile device 31 filters or preferences, to a smaller area, where fewer active displays 22 may be activated. The size of the sphere S1 may be expressed as a distance about or radius from the first user mobile device 31 or a particular controller.

With respect to the second sphere of influence S2, a smaller sphere may provide additional levels of privacy, intimacy, or personalization as the second user mobile device 32 interacts with the displays 22. For example, the second user may be a shopper or store associate who wants a department-wide view of alternative content, or narrow down a sphere of control to get more focused on specific products or locations.

The first and second spheres of influence S1, S2 may overlap, which may cause the controller 26 in communication with both spheres of influence S1, S2 to be challenged with respect to know which display device 22 is being controlled by which user mobile device 31, 32. Here, a controller 26-29 may receive additional information from the mobile devices 31, 32, for example, signal strength, device level metadata, and so on, to ascertain the relative locations, e.g., x-y coordinates, of the devices 31, 32, size of the sphere of influence of the devices 31, 32, or other attributes of the sphere useful for determining a communication between controllers 26-29 and user mobile devices 31, 32.

In some embodiments, triangulated signals between controllers 26, 27, and/or 28 may be used to calculate the distance and size of the first sphere of influence S1, distance of the mobile device 31 from a particular store location, and/or related information. Similarly, triangulated signals between controller 28 and/or other controllers at other locations of the store may be used to calculate the distance and size of the second sphere of influence S2, distance of the mobile device 32 from a particular store location, and/or related information.

In one example, a long range distance (K1) between first user mobile device 31 and controller 27 may provide one stream of data to establish a triangulation of a location of the mobile device 31 for determining what content to display to the requesting mobile device 31. In another example, a short range distance (K2) between first user mobile device 31 and controller 26 may provide a preferred connectivity point and indicate to the controllers 26-29 which displays 22 are requested to be changed with respect to content. In another example, a distance between first user mobile device 31 and controller 28 may be shared with another user mobile device 32, for example, shown as K3, which may be used to logically determine which displays need to be changed for each user, with deference going to user mobile devices closest to that display's location. Here, a device may communicate, for example, via line of sight (K4), with a controller 28 to change display content. This may be analogous to a remote control device using infrared (IR) signal to change TV channels directly. Channels may correspond to the types of content the user prefers for display.

A set of location coordinates may be established, for example, x-y coordinates. For example, a location L1 may correspond to an indexed location of a particular display 22C. An indexed location may refer to a known location of a controller on a store map. For example, an engineering drawing may be used to determine that a controller that is located in the toys department is a predetermined distance (X) from the front wall of the store and another predetermined distance (Y) from the sidewall. The controller ID, the department, and the X,Y coordinates may serve as elements in the index and used by the system to determine what content is displayed as the mobile device 31, 32 roams through various locations. Therefore, the X, Y coordinates may be used by a controller to identify electronic displays 22 and/or audio speakers 23 for outputting alternative content in response to instructions provided by a user mobile device 31, 32. Alternatively, a mobile device 31, 32 may use an index to communicate to the controllers 26-29 which displays 22 are to provide alternative content. An index may be pre-loaded on the mobile device 31, 32 during the mobile application download or during an update. In this situation, additional elements, e.g., processed by a local context filter 411 shown in FIG. 7, such as GPS location may be included in the index so that the mobile device 31, 32 may use its onboard sensors such as GPS device or the like to match its location against the index.

In another example, a location L2 corresponds to a determined distance from mobile device 31 from a known reference datum such as the edges of the sales floor, for example, a wall (X) and wall (Y). Location coordinates may be used to identify which displays are within a sphere of influence of the mobile device user 31.

In another example, a location L3 corresponds to a determined distance from mobile device 32. Locations of users are not known explicitly by display controllers, but may be used in assisting the device in identifying which displays are within the sphere of influence to control.

FIG. 1 illustrates several operation examples. In one example, at display 22A a default display state may be provided, since the display 22A does not receive a request for displaying alternative content. In some embodiments, audio speakers 23 may, in a default state, play regularly programmed audio. Displays 22 may revert from an alternative display state back to the default state either by receiving instruction from a mobile device or after a certain timed period of inactivity.

In another example, digital display 22B may receive a request content from controller 26 to display content from content server 40 under the control of first mobile device 31.

In another example, alternate display 22C may be in communication with a separate controller 27 to display content under the control of mobile device 31 in parallel with content provided by from other controllers. Thus, each display 22 may require different media and information to display particular content, but such content may work in harmony depending on user filters and preferences.

In another example, alternate display device 22D displays content requested from controller 28 by the second mobile device 32.

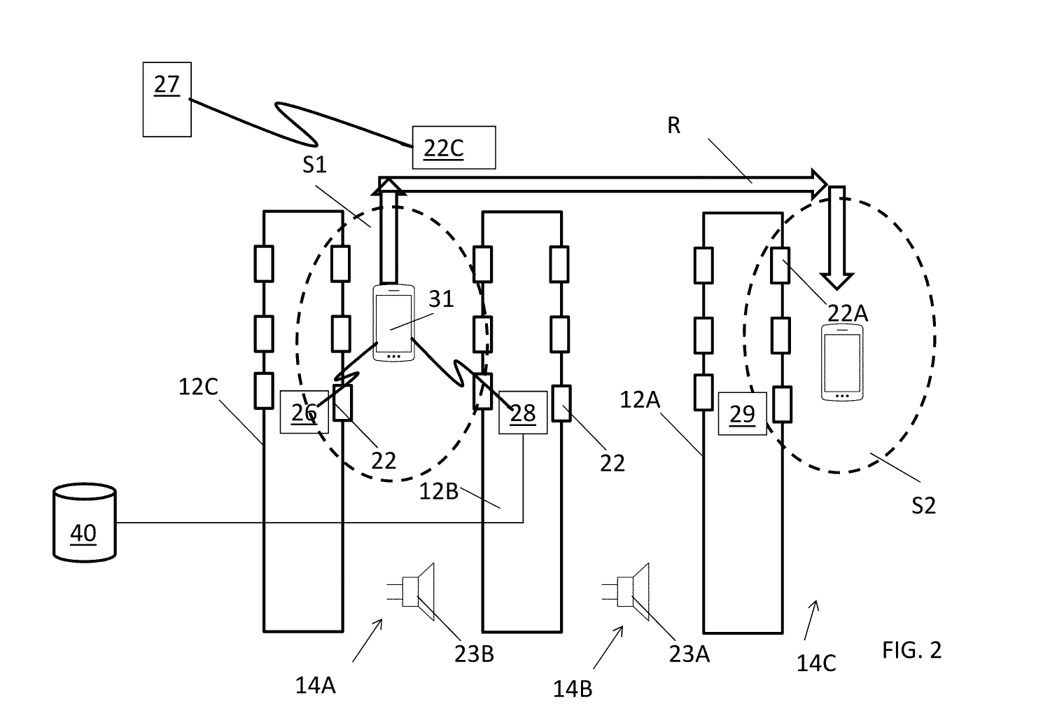

FIG. 2 is a block diagram of a retail store environment in which other embodiments of the inventive concepts are practiced. FIG. 2 illustrates how alternative display content can be used to help guide customers and store associates between store locations. For example, this may be achieved by providing directional indicators as a result of a mobile device making a request for a route R through the store. Such a route R may be helpful in stocking, shopping, or picking items for fulfillment. Other use cases may include a guided tour, audit, re-stocking, or the like.

In FIG. 2, a display 22B may show directional and way-finding guides to user 1 as a result of the mobile device 31 requesting content from controller 26 at shelf 12C. Another display, e.g., 22D may show way-finding or navigation content from another controller 27 as a continuation of the content at other displays. For example, one or more displays at a starting location, for example, aisle 14A, may direct users in a direction toward an end location, for example, aisle 14C. Displays 22 along the route R may continue along a path of travel. Displays 22 in aisle 14C may display arrows (e.g., see displays 105, 106 in FIG. 3), illuminated or blinking LED lights, or other indicators to continue to direct the user toward the modular, bay, shelf, and/or item that represents the location of the destination. Controllers 26-29 may receive requests for alternative content in succession as the mobile device 31 travels from one location to another. The activity may be interpreted by the controllers 26-29 to update content on the adaptive displays 22.

FIG. 3 is an illustrative view of example screenshots of default state 101 and alternative state 102-106 content, in accordance with some embodiments. The examples 101-106 may include different ESL display states, and changes there between.

Example 101 illustrates a default display state. For example, a display 22 may be an ESL display that displays programmed content such as a price, inventory information, and so on. The display 22 may display other content as default content depending on size, format, orientation, and interactivity of the display. Other variations may include interactive maps, help buttons, category information, department information, item information, and so on. A display 22 may change states from another state to the default state either in response to an instruction from a mobile device 31, 32, or after a certain timed period of inactivity.

Example 102 illustrates an alternative state. An alternative state may be displayed and distinguished from other states by a blinking LED 51, or audio speaker or other communication. Multiple lights or features may be used if multiple users are in close proximity to the same display 22. In more complex environments, displays 22 may be segmented to display multiple alternative contents simultaneously to accommodate different user requests for content. As described above, controllers in accordance with some embodiments differentiate between user content requests. The alternative content may be displayed within a predetermined distance from a mobile device 31, 32 to allow multiple shoppers in a general area (e.g, a same aisle) while filtering by different preferences.

Example 103 illustrates an instance where a store associate requests alternative content on one or more displays 22, and special information specific to the associate may be displayed. Special information may include in this example, but not be limited to, supply chain data, sales data, margin data, days-on-hand, mark-downs, recalls, task management, productivity goals, and other relevant information.

Example 104 illustrates an instance where a shopper requests alternative information. Here, a controller receiving the request from the user mobile device may pull additional information from external data sources. Additional information may include but not be limited to product ratings, reviews, descriptions, opinions, bundle promotions, coupons, purchase options, payment options, layaway information, and so on.

Example displays 105 and 106 illustrate alternative content in the form of guided directions and way-finding that may help store associates and customers locate a desired display location. In this scenario, referring also to FIG. 7, a filter options system 421 may receive as an input an item number. The mobile device application 431 may communicate the item number and locate its item location from a store item system library 423. The mobile device 405 may also transmit its location information. The system may calculate a path between the device 405 and the item location. Finally, displays 422 that are along the route would be changed to the relevant arrows and markers to provide direction. As the device 405 moves along the path, the system could use the mobile device's GPS, accelerometer, or related onboard device, or a manual input, to repeat the above process and update the process as the user approaches the item location.

FIG. 4 is a diagram of a component model for an adaptive shelf display, in accordance with some embodiments.

A server system 202 includes a catalog of filters 204. The server system 202 may be the same as or similar to, or include, the content server 40 of FIGS. 1 and 2. The filters 204 can be provided by the server system 202 as an input to a device controller 210, which modifies content displayed on a store device 220 such as a digital display or electronic shelf label. The filters 204 may also be output as a flat file or the like to a storage device of a mobile device 205, which may be similar to a mobile device 31 or 32 shown in FIGS. 1 and 2.

An example of a catalog of filters 204 is illustrated at FIG. 6. The filters may be organized as records for storage at a database of the server system 202. In brief overview, the catalog of filters 204 provides a means for selecting a type of filter(s) that the user may enable. Display codes are provided for the filter defining the type of processing needed.

A display code may instruct the controller 210 what business logic it needs to perform as the mobile device 205 transmits its information. The mobile device 205 may provide the filter/display code, along with the accompanying metadata to a local receiver system 206 in close proximity to the mobile device 205 so that a communication may be established. In the abovementioned “allergy-free” example, the display code ‘0000002’ shown in FIG. 6 may be output to the receiver system 206 required to process data pertaining to allergies. The mobile device 205 may transmit in addition to the display code a search criteria such as ‘gluten free’, ‘MSG free’, etc. The receiver system 206 receiving the display code in response retrieves a set of search criteria used by the server system 202 in the cloud computing environment (see FIG. 7) to find the items that match the allergy parameters in an item file library, e.g., file library 423 in FIG. 7 where that information is stored. As the server system 202 finds items that match the allergy search, the system 202 then looks up which of its shelf displays are associated to those items; and sends a signal to the relevant controllers, e.g., 26-29 of FIG. 1 or controller 210 of FIG. 2 to change the display outputs accordingly, for example, devices 212 shown in FIG. 2. The output display 213 may display for the user any filters, data, preferences, or settings entered into the mobile application that is associated with the filter code. For example, if a user selects “Allergy Filter”, the output screen 213 may display the settings, fields, and data that the user would need to interface with in order for the mobile device 205 to transmit that data to the receiver unit along with the code of what type of data it is. Here, at the output screen 213, a user may opt out of programs and/or interactions.

Alternatively, if a display code is provided for displaying “WIC” or “Snap” Items, the additional data transmitted from the mobile device 205 may be directed towards a different set of business logic and libraries to determine what is displayed.

Referring again to FIG. 6, other codes may include but not be limited to wayfinding, emergency notification, stocking, picking, ratings, reviews, and associate training.

Referring again to FIG. 4, the mobile device 205 includes a hardware processor that processes contexts used for filtering of content. The mobile device uses the catalog of filters, e.g., illustrated at FIG. 6, to organize the user inputs needed to transmit to the store controller 210. Accordingly, the mobile device 205 may process a filter field that controls the type of content of interest, or content-specific filter, to the user, and filtering or changing content to be displayed at the electronic display 220. The mobile device 205 may output a change in content input that is received by the device controller 210.

Accordingly, the controller 210 may process the inputs from the receiver system 206, server system 202, and content library 423 (see FIG. 7). For example, the controller 210 may wait for a mobile device 205 (or mobile devices 31, 32 of FIGS. 1 and 2 or mobile device 405 of FIG. 7) to interact with the receiver system 206. This may be a direct signal from the mobile device, for example, a communication technology such as BLE, WiFi Direct, NFC, IR, and so on. Once the receiver system 206 is triggered by the mobile device 205, the receiver system 206 passes data it collects from the device to the server system 202, which may be part of a cloud computing system 420. The server system 202 combines information from the receiver system 206, which may include mobile sphere of influence data, filter data, device sensor data, etc. with library data such as item attributes, marketing content, etc.

Alternatively, the mobile device 205 may directly submit metadata to the server system 202, and then wait for the server system 202 to push library content down to the controller 210, at least partially bypassing the receiver system 206.

The input interface 214 shown in FIG. 4 may include an application page or the like that permits the user to select attributes for filtering. For example, a display 212 may present a box providing an option to enable a particular filter, e.g., “Allergy Filters,” or to “Opt-out” from selecting any filters.

The output interface 215 may output specific details required to complete a selected filter. In the abovementioned allergy example, the user may be prompted to select from a list of known allergies from which to further filter, such as gluten, sugar, dairy, nuts, and so on. These field entries generated from the user selection may be provided in addition to a display code to the receiver system 206 or the server system 202.

In some embodiments, the input interface 214 and/or output interface 215 provide the inputs and outputs relative to the user-controlled settings for adjusting a sphere of influence S1, S2. Filter options 421 and a location processor 425 (see FIG. 7) may process algorithms and include logic that determines the affected sphere of influence S1, S2.

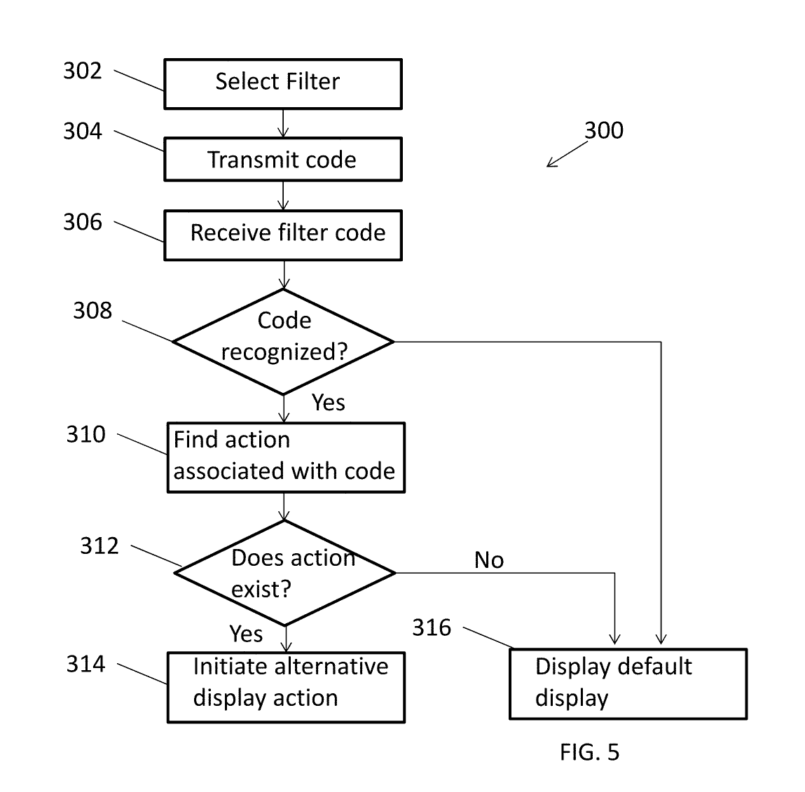

FIG. 5 is a flow diagram of a method 300 for controlling a presentation of digital content at a store display, in accordance with some embodiments. The method 300 may be performed by physical elements of a retail store environment illustrated in FIGS. 1 and 2, or the component module illustrated at FIG. 4.

At block 302, a filter is selected on a portable computing device, for example, mobile device 31 or 32 of FIGS. 1 and 2. The selected filter is derived from a list of filter options provided to the portable computing device from a catalog of filters 204 shown and described with reference to FIG. 4. For example, a user may select a filter entitled “Women owned company qualified.”

At block 304, a display code is transmitted. For example, referring to FIG. 6, a display code 00005 corresponding to a filter “Women owned company qualified” may be output from a customer's mobile device 205 and received (block 306) by the receiver system 206. A user mobile device may provide the display code, along with the accompanying metadata.

At decision diamond 308 a determination is made whether the code is recognized. A code is present if there is corresponding computer logic to process the accompanying metadata transmitted with the code. For example, the receiver system 206 may receive a code for “stocking” from an associate mobile device user. Along with that code, the receiver system 206 determines if additional metadata such as the associate user ID, job code, or other task information is transmitted. This information is then output to the server system 202 (or cloud computer 420 in FIG. 7.

An alternative display action includes the set of instructions from the server system 202, 420 for changing the display device to a different display.

Accordingly, the controller 210 communicates with the server system 202 to process and determine the action. If the server 202 cannot determine an action from the available local metadata from the receiver system 206, then default display content is displayed (block 316). Otherwise, the method 300 proceeds to block 310, where the determined action associated with the code/metadata is displayed (block 314).

FIG. 7 is a block diagram of a schema illustrating example contexts that supplement content selection and formatting for an adaptive display, in accordance with some embodiments.

A plurality of local contexts 402 used for filtering may be stored at a data repository, for example, content server 40 illustrated and described in FIG. 1. Example contexts may include but not be limited to data related to date, time, market, geography, assortments, items, previous and current user location, other user status and location, compass headings, direction data, weather, environment factors, sales floor layouts, maps, user roles, employee or associate access or authentication, labor timecards, schedules, store management control settings, content prioritization indices, display formats and types, or a combination thereof. The local context data 402 may be analyzed.

In some embodiments, the server system 202 shown and described in FIG. 4 is responsible for analyzing the local contexts 402, either directly from the mobile device 205 or receiver system 206. For example, the server system 202 may ratify a relevant context, which may include determining whether the context is relevant. The mobile device 205 (FIG. 4) or 405 (FIG. 7) may participate in this exchange via a store infrastructure 206, e.g., wireless fidelity (WiFi) or other data network, which communicates with the server system 202, or cloud computer 420, which in response provides data via the controller 420. In other embodiments, the mobile device 205, 405 may pass context data to the receiver system 206, which in turn passes the context data to the server system 202 for analysis. Regardless of whether the mobile device, controller, or receiver providing context data, it is the server system 202 that performs the analysis on the context data.

The mobile device 405 includes a hardware processor that processes contexts used for filtering of content. The mobile device 505 may be similar to a mobile device 31 or 32 shown in FIGS. 1 and 2 or mobile device 204 shown in FIG. 4. Mobile device 405 may process a filter field that controls the type of content of interest, or content-specific filter, to the user, and filtering or changing content to be displayed at the electronic display 220. In doing so, the mobile device 405 may include a local context filter 411 and customer profile filter options 412 executed by the mobile device processor. The mobile device 405 here combines both local and customer contexts and outputs them to either the receiver system 206 or the server system 202/cloud computer 420. The mobile device 405 also transmits a corresponding filter code that identifies the type of context metadata to be transferred.

A cloud computer 420 may include but not be limited to a filter options system 421, a physical locator processor 425, and a content library 423, and/or server system 202 illustrated in FIG. 4. The filter options system 421 receives context data inputs 402, which are used for filtering.

The filter options system 421 provides central processing functions for the server system 202. A mobile device 405 may communicate a local filter (such as geographic location, date and time, language, etc.) along with a customer filter option, or filter code such as ‘Ratings and Reviews’. This communication may happen directly between the mobile device 405 and the server system 202, or by way of a receiver unit 206 (FIG. 4) in proximity of the mobile device 405. The server system 202 may use the geography, date and time, language, or other information to determine what store display 212 and library content need to be activated.

A physical location processor 425 may perform the foregoing by collecting what it knows about the mobile device 405 along with an index of locations of its devices. For example, the processor 425 may access the GPS or other data and compare it to the known locations of displays on the network. The display may be selected by the server and it then sends a signal to activate the respective controller and accompanying display. The physical location processor 425 manages the location of known display locations and recognizes data coming from a mobile device to determine a match in locations.

The server system 202 will also know from the filter code that it will be “Ratings and Reviews” content that needs to be displayed. The server system 202 then uses the content library 423 to pull the relevant content data and then uses the store and aisle location it collected to activate the content data associated to ratings and reviews on the relevant displays in the store and aisle location.

The combination of elements illustrated in FIG. 7 permit customer content to be displayed at one or more display devices, e.g., ESLs, digital displays, kiosks, audio speakers, lighting, aroma or other sensory devices, tactile generators, and/or other apparatus that may communicate via touch, sound, sight, and/or smell to store customers. This output is achieved if response to a determination that a customer opts-in, filter options are selected, proximity is detected, and local contexts are analyzed.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

What is claimed is:

1. A system that controls a presentation of digital content, comprising:
at least one electronic display positioned in a retail shopping environment;
a mobile device that filters, changes, or replaces content for display at the electronic display;
at least one controller that controls an output of the content to the at least one electronic display in response to a request for a change in content received from the mobile device;
a user-configurable sphere of influence that establishes a distance of the mobile device from the at least one controller and determines whether at least one electronic display receives the controlled output of content based on proximity of the mobile device from the at least one controller.

2. The system of claim 1, further comprising a content server that stores alternative content that replaces the content for display on the electronic display in response to the request for the change in content.

3. The system of claim 2, wherein the alternative content guides users between store locations, by providing directional indicators in response to the mobile device generating a request for a route through the retail shopping environment.

4. The system of claim 2, wherein the content server stores a plurality of records that include content item data and associated index codes.

5. The system of claim 1, wherein the electronic display includes at least one of a visual display, digital sign, or a kiosk display, an end cap display, or an electronic shelf label.

6. The system of claim 1, further comprising an audio device that outputs audio content, wherein the mobile device that filters, changes, or replaces content for output from the audio device.

7. The system of claim 1, wherein the mobile device includes a content-specific filter field that controls the type of content of interest to the user, and wherein the electronic display displays a alternative content in response to the content-specific filter field.

8. The system of claim 1, wherein a alternative content is displayed within a predetermined distance from the mobile device to allow multiple shoppers in a general area while filtering by different preferences.

9. The system of claim 8, wherein the controller is in proximity to a first shopper and a second shopper of the multiple shoppers, wherein the controller uses metadata from each shopper's mobile device to determine which displays of the at least one electronic display is capable of being changed to an alternative display state for each shopper.

10. The system of claim 9, wherein each of the first and second shoppers is in a different sphere of influence, and wherein the metadata is used to distinguish the first and second shoppers.

11. The system of claim 1, further comprising a physical location processor that manages the location of known display locations and recognizes data coming from a mobile device to determine a match in locations.

12. The system of claim 1, wherein the mobile device transmits to allow the at least one electronic display to pull content associated to the index.

13. The system of claim 1, wherein the mobile device passively controls what content is filtered on the at least one electronic display as the user walks through a store in the presence of the at least one electronic display.

14. The system of claim 1, wherein the size of the sphere of influence is adjustable.

15. A controller that controls a presentation of digital content, comprising:
a special purpose processor that modifies content displayed on an electronic display in a retail shopping environment in response to a request for a change in content received from a remote mobile device; and
a special purpose processor that forms a user-configurable sphere of influence that establishes a distance from the mobile device, the special purpose processor further establishing whether the electronic display receives alternative content in response to the request for the change in content based on a proximity of the mobile device.

16. A system that controls a presentation of digital content, comprising:
at least one electronic display positioned in a retail shopping environment;
a mobile device that outputs a request for a navigational route through the retail shopping environment;
at least one controller that receives the request from the mobile device, the request including a request for navigation content; and
a content server that stores the navigation content, the at least one electronic display displaying directions for the navigational route according to the navigation content.

17. The system of claim 16, wherein the navigational route is for stocking, shopping, or picking items of interest, or for a guided tour, audit, or re-stocking.

18. The system of claim 16, wherein the at least one controller receives a request for alternative content when the mobile device travels to a different location, the alternative content including direction data to the different location.

19. The system of claim 16, wherein different electronic displays display the directions for guiding the mobile device along the navigational route.

20. A method for controlling a presentation of digital content, comprising:
determining if a shopper's mobile device opts-in or accesses a network for controlling a display of data at an electronic display;
selecting at the mobile device a filter option;
ratifying a relevant context, including determining whether the context is relevant;
determining a proximity between the mobile device and a controller;
providing the filter option from the mobile device to the controller;
providing by the controller alternative content based on the proximity of the mobile device from the controller and the filter option; and
displaying custom content on the electronic display near the shopper in response to a determination that the customer opts-in, the filter option is selected, the proximity is detected, and the context is relevant.
